(19) United States
(12) Patent Application Publication
(10) Pub. No.: US 2010/0225450 A1
(43) Pub. Date: Sep. 9, 2010

(54) DELIVERING MEDIA AS COMPENSATION FOR COGNITIVE DEFICITS USING LABELED OBJECTS IN SURROUNDINGS

(75) Inventors: Russell J. Fischer, Bernardsville, NJ (US); George Collier, Califon, NJ (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/720,140

(22) Filed: Mar. 9, 2010

Related U.S. Application Data
(60) Provisional application No. 61/158,605, filed on Mar. 9, 2009.

(51) Int. Cl. H04Q 5/22; G06F 3/048

(52) U.S. Cl. 340/10.4; 715/709

(57) ABSTRACT

A computer implemented method and system for assisting a person with completion of a task. The method comprises recognizing one or more objects in an environment associated with said task; presenting media that demonstrates a use of the one or more objects associated with said task to the person; and interacting with the person throughout said task to measure progress towards the completion of the task. The system comprises a processor; a knowledge base operable to store state information, rules, attributes and associations, associated with an environment, objects associated with the environment, and one or more users; a server module operable to recognize one or more objects in an environment associated with said task, present media that demonstrates a use of the one or more objects associated with said task to the person, and interact with the person throughout said task to measure progress towards the completion of the task.

### CROSS REFERENCE TO RELATED APPLICATION

This application takes priority from U.S. Provisional Application 61/158,605 filed on Mar. 9, 2009, which is hereby incorporated by reference in its entirety.

### BACKGROUND

The present application relates generally to computer systems, communications and networks, and more particularly to assisting people with cognitive deficits by delivering media to these computer systems.

Traumatic brain injuries (TBI) affect, on average, over 20,000 men and women in the U.S. Armed Forces each year. TBI may range from a mild concussion characterized by a confused state and loss of consciousness to severe TBI caused by an object penetrating the skull and the outer layer of the brain. From 2000 to 2009, there were over 161,000 reported incidents of TBI trauma affecting members of the U.S. Armed Forces. Advancements in medical technologies and life saving surgeries have resulted in many members of the military surviving the events that resulted in TBI. However, life after TBI is often extremely challenging as the injured person has to relearn the most basic tasks.

Within the general (civilian) population of the United States, the annual incidence of TBI is estimated at 102.8 injuries per 100,000 people. In males, the number of injuries peak between the ages of 15 and 24 (248.3 injuries per 100,000 people) and again above 75 years of age (243.4 injuries per 100,000 people). The number of injuries in females peaks in the same age groups, but the absolute rates are lower (101.6 and 154.9, respectively). These rates underestimate the true incidence of head trauma because patients with milder symptoms at the time of injury usually are not hospitalized.

About three-quarters of traumatic brain injuries that require hospitalization are nonfatal. Each year, about 80,000 survivors of TBI will incur some disability or require increased medical care. Direct medical costs for TBI treatment have been estimated at $48.3 billion per year, including the costs of hospitalization for acute care and various rehabilitation services. In the years 1988 to 1992, reports of average length of stay (LOS) for the initial admission for inpatient rehabilitation range from 40 to 165 days. In one multicenter study (the Model Systems study), the average rehabilitation LOS was 61 days, and the average charge was $64,648 exclusive of physician fees. Total charges averaged $154,256.

TBI can cause a wide range of functional changes affecting thinking, language, learning, emotions, behavior, and/or sensation. It can also cause epilepsy and increase the risk for conditions such as Alzheimer's disease, Parkinson's disease, and other brain disorders that become more prevalent with age. TBI and the brain disorders associated with TBI can cause cognitive deficits, i.e., the ability to think and concentrate on a task. Often, one of the goals of rehabilitation for an injured person suffering from TBI is to provide the person with the ability to function independently in the same manner as prior to the brain injury.

An injured person's every day environment is filled with objects associated with the basic fundamentals of everyday life. For example, a toothbrush is associated with brushing and cleaning teeth. However, a person suffering from TBI may not recognize the toothbrush or connect the toothbrush with its associated use. A person suffering from TBI may also have difficulty in creating and/or following a daily schedule of planned activities. Sometimes a caretaker is needed just to assist the injured person throughout the day. However, the cost associated with having a constant caretaker alongside the injured person is often prohibitive and there are usually not enough caretakers available to assist every injured person regardless of the cost.

Thus, there is a need in the art for a device that assists a person with cognitive deficits or who suffers from TBI and allows the person to function in an everyday environment without a caretaker present.

### SUMMARY

A system and method for assisting a person suffering from a cognitive deficit by delivering media to the person is provided. In one embodiment, the method comprises recognizing one or more objects in an environment associated with said task; presenting media that demonstrates a use of the one or more objects associated with said task to the person; and interacting with the person throughout said task to measure progress towards the completion of the task.

In one embodiment, the system comprises a processor; a knowledge base operable to store state information, rules, attributes and associations, associated with an environment, objects associated with the environment, and one or more users; a server module operable to recognize one or more objects in an environment associated with said task, present media that demonstrates a use of the one or more objects associated with said task to the person, and interacts with the person throughout said task to measure progress towards the completion of the task.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an overview of how the present invention functions.

FIG. 2 illustrates one embodiment of a method for how a healthcare provider can create a script associated with objects in an environment.

FIG. 3 is an example of several tags that can be used to identify objects in an environment.

FIG. 4 is one example of a task that can benefit from assistive media.

FIG. 5 is one embodiment of a data flow diagram for implementing the present invention in a workplace environment.

FIG. 6 is an embodiment of a method for how a user with a cognitive defect can input information into a computing device.

FIG. 7 illustrates a high level control loop of the system in one embodiment.

FIG. 8 shows system computation flow in one aspect.

FIG. 9 is a diagram illustrating components of the present disclosure in one aspect.

FIG. 10 illustrates a high-level use case diagram in one aspect.

FIG. 11 shows examples of properties and their domains and ranges.

FIG. 12 illustrates example properties of an action object as an example.

FIG. 13 illustrates an example class hierarchy of a knowledge model.

FIG. 14 illustrates example objects in a knowledge model with directed arcs representing properties and their ranges.

### DETAILED DESCRIPTION

In one embodiment, the present disclosure addresses providing assistance to people with cognitive deficits by recognizing an object in the person's environment and delivering media associated with the object to the person. The present disclosure further addresses enabling automatic assistance to users to help them begin, work on, or finish tasks in these environments by providing media that demonstrates how to perform these tasks using the identified objects in the environment. Unlike existing productivity aids in which the user has sufficient knowledge of how to complete a task, the present disclosure in one aspect describes operating as an augmentation or aid for a person with cognitive deficiencies. An exemplary productivity aid invented by Benjamin Falchuk is described in U.S. patent application Ser. No. 12/691,077 “METHOD AND SYSTEM FOR IMPROVING PRODUCTIVITY IN HOME ENVIRONMENTS”.

In one embodiment, a portable computing device, such as a mobile phone, personal digital assistant (PDA) or tablet computer stores information about the environment and the objects in the environment. In another embodiment, the portable computing device identifies or recognizes objects in the environment via a bar code or an RFID tag, communicates the identity of the objects to a server, and the server responds by providing media to the portable computing device. The computing device then plays the media for the user and the user may further interact with the media. The system reminds the human of things the human might have forgotten about the task he or she is undertaking, and as a result, increases productivity and quality of the task.

The system and method may work either in concert with existing services, making use of information sensed through the existing service, or as a stand-alone new service to an environment which makes use of new sensing equipment. The user may issue directives into the system via the portable computing device. In one embodiment, the computing device is a cellular phone and directives are issued via a numeric keypad, touch screen, or a voice interface. Some computing devices are also capable of detecting motion and direction, enabling the user to enter a directive by motioning or gesturing with the computing device in his hand.

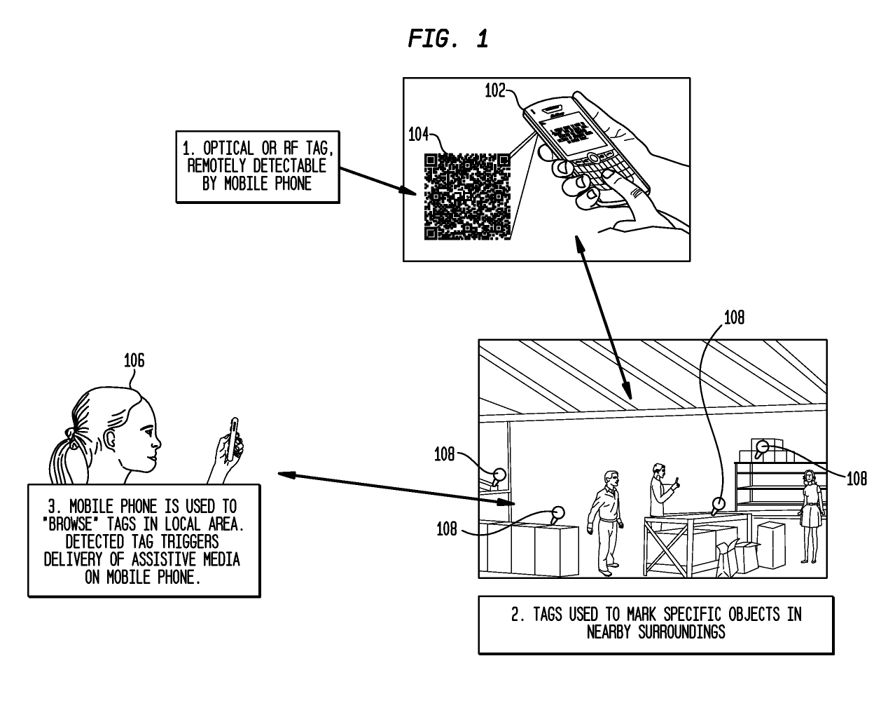

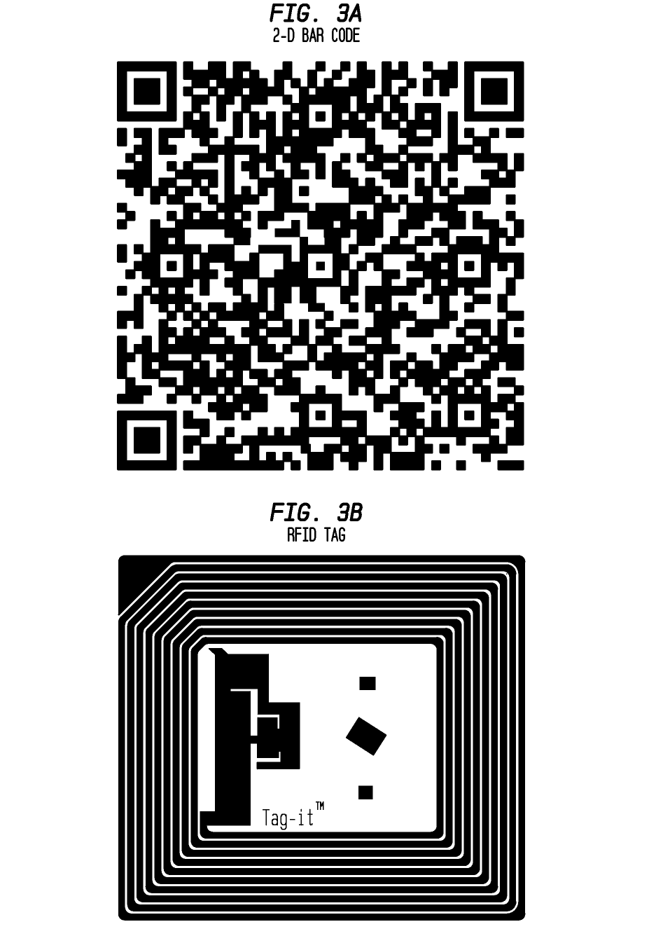

FIG. 1 is an overview of how one embodiment of the present invention functions in a work environment. A portable computing device 102, such as a mobile phone, is equipped to detect an ID tag 104 attached to an object 108. The ID tag 104 may be an RFID tag (shown in FIG. 3A) or a 2-D bar code (shown in FIG. 3B). The tags 104 are attached to various objects 108, e.g., machinery or equipment, in the work environment. The computing device 102 is operable to detect, the tag 104, and when the tag 104 is detected, assistive media that demonstrates the proper use and function of the object is displayed to the user 106.

In one embodiment, the tag 104 is a “near field” RFID tag. The computing device 102 will only detect the presence of the tag when it is in the immediate vicinity of the tag. Assistive media for an object will only be delivered to the user 106 when the user is in the same area as the object 108.

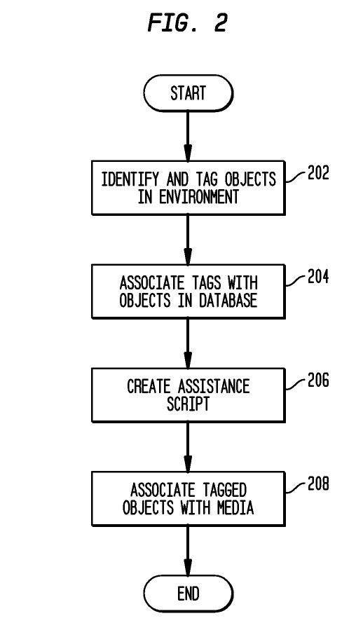

FIG. 2 illustrates an embodiment of one method for creating a script associated with an object. A ‘script’ is a sequence of step-by-step instructions or actions associated with an object. When these actions are performed in sequence, the user can properly use the object to perform a task. For example, a toothbrush may be associated with the actions ‘turn water on at sink’, ‘wet toothbrush’, ‘open toothpaste’, ‘put toothpaste on toothbrush’, ‘close toothpaste’, ‘brush teeth’‘rinse mouth’, ‘rinse toothbrush’, ‘turn water off at sink’. All of these actions, performed in sequence by the user, cause the user to accomplish the task of brushing his teeth.

In one embodiment, the script is programmed by a healthcare provider or vocational caretaker into the server. At step 202, the healthcare provider reviews the environment in which assistance is to be rendered and tags objects in the environment that may benefit from assistive media. At step 204, the healthcare provider registers the tagged objects to a database and associates the tagged objects with any of the parameters necessary for later use of the object. Such parameters include, but are not limited to, a description of the object, the location of the object, and a task associated with the object. At step 206, the healthcare provider creates an “assistance script” that defines a sequence of steps that comprise the full task for which the disabled individual requires assistance. At step 208, the healthcare provider decides which type of media is appropriate to assist the individual through each step of the task and associates the media with one or more objects. Media may be a video that demonstrates the task, audio instructions, or an SMS message. Each step of a task sequence may be associated with its own media, or there may be one continuous media for an entire task.

In one embodiment, each tagged object is associated with a “context trigger” that is intended to confirm that a step or a task has been completed. The context trigger may be a voice command, such as “task complete” or a key press, such as pressing the “u” key on a mobile phone. The context trigger may also be a physical gesture or a change in location of the user. By monitoring a series of context triggers over time, the user's progress through a sequence of tasks may be measured.

FIG. 3 provides examples of tags that may be placed by the healthcare provider on objects in the user's environment. These tags include RFID tags and two dimensional barcode tags. Each tag 104 is unique, allowing the tagged objects 108 to be uniquely identified by a tag reader, i.e., the computing device 102. When a tag 104 is read by the computing device 102, the tag 104 is decoded and the object 108 associated with the tag 104 is identified to the user.

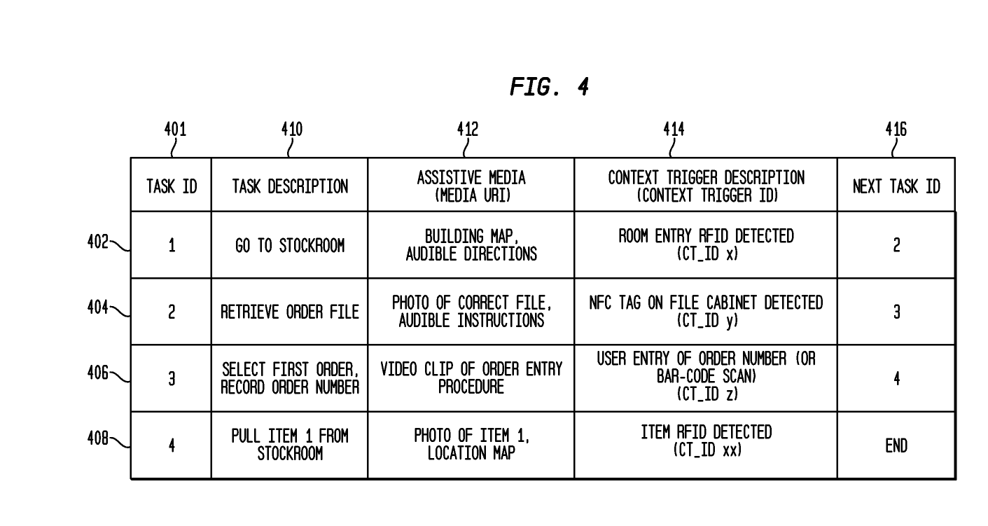

FIG. 4 is one example of a task that can benefit from assistive media. As an example, the assigned task is “retrieving an item from a stockroom”. The task is decomposed into four different task steps 402, 404, 406 and 408 by a vocational caregiver. Each step is assigned a unique “task ID” 401. In the present example, task step 402 is assigned task ID “1”, step 404 is assigned task ID “2”, step 406 is assigned task ID “3” and step 408 is assigned task ID “4”. Each step is also associated with the following parameters “task description” 410, “assistive media” 412, “context trigger description” 414 and “next task ID” 416.

As an example of how the present invention may function in a workplace environment, the task of retrieving an object from a stockroom may be triggered by another user, e.g., a coworker or supervisor. The user, who in this example suffers from a cognitive deficit, is equipped with a mobile phone that also has an ID tag reader. Task ID “1” 402 “go to the stockroom” is associated with assistive media that helps the user locate the stockroom. Such assistive media for task ID “1” 402 may be a building map or audio directions to the stock room. The computing device may rely on assisted GPS, a pedometer, a compass, or other well known geolocation services built-in to computing devices to track and direct the user to the stock room. A context trigger event, such as detection of the user's entry into the stockroom via an RFID tag, causes advancement to the next step in the task, i.e., task ID “2”. Task ID “2” 404 “retrieve order file” is associated with an assistive media that is a photograph of the correct file and/or audio instructions that describe the file. The proper assistive media for task ID “2” 404 is presented to the user when the user approaches a filing cabinet tagged with a “near field” RFID tag. The user acknowledges that he understands the assistive media and advances to the next step in the task, i.e., task ID “3” 406, by pressing a button, such as the “#” key on the mobile phone. Once the user advances to the next step, the mobile device displays an appropriate assistive media for task ID “3” 406. For example, the assistive media could be a video of “how to record an order to a file”. The user performs the step in the overall task and acknowledges completion of task ID “3” 406 to advance to the next step. At the final step in the task, task ID “4” 408, another appropriate assistive media is displayed to the user, e.g., a photo of the product to be retrieved from the stockroom along with a map of the location of the product in the stockroom. A signal from an RFID tag attached to the product retrieved from the stockroom is detected by the mobile phone. The detected signal acts as a context trigger indicating that all of the steps in the task have been completed and that the assigned task is also complete.

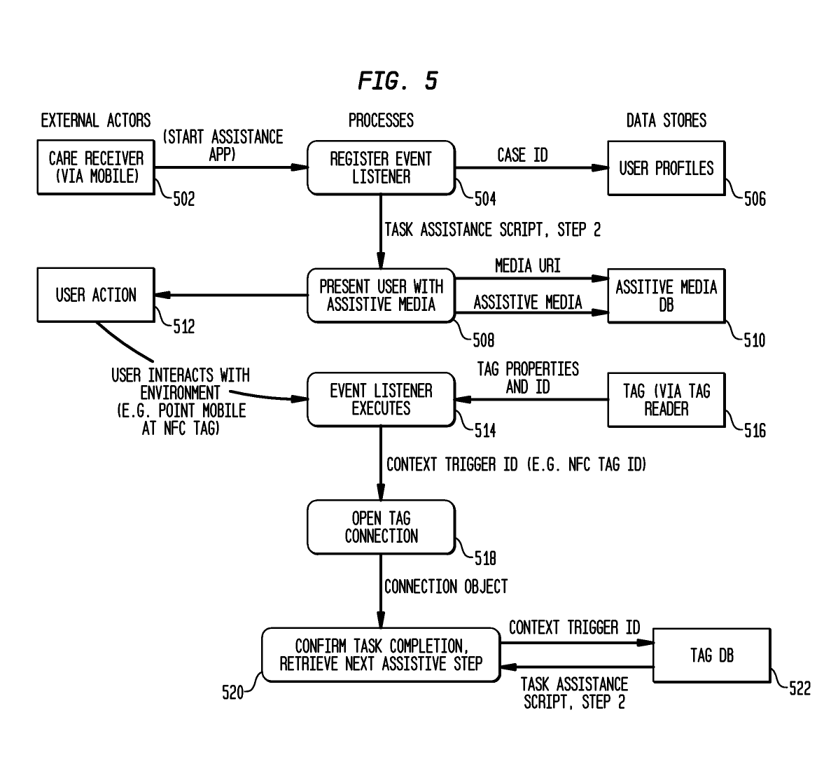

FIG. 5 is one embodiment of a data flow diagram for implementing the present invention in a workplace environment. The method begins at step 502, when a user initiates the assistance application on a portable computing device. In this example, the portable computing device is a mobile phone, but may also be a personal digital assistant (PDA), laptop or tablet computer. At step 504, the assistance application “listens” for an event and also retrieves an appropriate “user profile” 506 that corresponds to the user of the mobile phone. Different users may be associated with different assistance scripts based on their job locations and/or job functions. Each user may benefit from different assisted media specifically associated with his/her job function and disabilities. In one embodiment, the mobile phone communicates a “case ID” to a server (not shown) to retrieve the appropriate “user profile” 506. The mobile phone continues to listen for an event or an event trigger that indicates the start of a preprogrammed assistance script. Such an event trigger may be the detection of an RFID tag attached to an object in the workplace. Once an event trigger is sensed by the mobile phone, the method proceeds to step 508 and the mobile phone retrieves an assistive media ID (media URI) from the Tag database 510. The assistive media may be stored locally or on a remote server. The media ID is used to request media from an “assistive media database” 512. At step 514, the assistive media is displayed to the user. The assistive media may be video, audio instructions, a message displayed to the user, a photograph, or any combination of images, audio and video used to assist the user in progress towards completion of the task.

The user interacts with the assistive media at step 514 to indicate completion of the step associated with the assisted media. The interaction may be a key press on the mobile phone, or a gesture or an audio command, or any other detectable interaction with the mobile phone that indicates the step is complete. For example, the user may point or place the mobile phone near an RFID tag attached to an object, indicating that the user has discovered an object required for completion of a task. This interaction is also known as a “context trigger” and indicates advancement of the user to the next step in the task.

The context trigger causes the method to advance to step 516. At step 516, the mobile phone is placed into “listening” mode again and listens for a signal from “RFID tags” 518 in the environment associated with the current task. The presence of these objects, as indicated by a signal from an RFID tag, functions as another context trigger associated with the next step in the task.

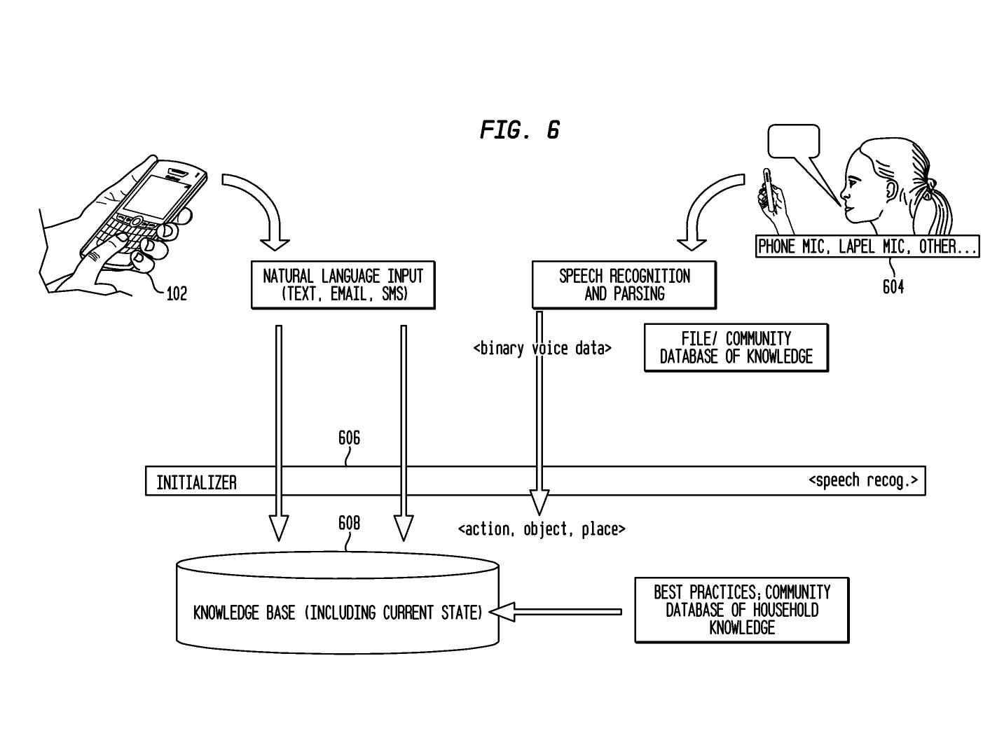

FIG. 6 illustrates one embodiment of a method for how a user with a cognitive deficit can input information into the computing device 102. A user may enter data, for instance, in natural language, using for example, texting, email SMS as shown at 602. A user may also enter voice data via, for example, a microphone of a mobile device as shown at 604. Such entered data may be parsed and processed using a speech recognition or language parsing tool 606. In another embodiment, data may be entered into the computing device 102 by shaking, tilting, or gesturing with the computing device 102 in hand. The processed data is stored in a knowledge base 608.

The system knowledge base 608 is a model that encodes information in machine-readable form. This readable form then allows the system to compute over the information, making inferences and suggestions on how to perform a task using an object identified by a tag. In one embodiment, the model uses a database of knowledge 610 preprogrammed by the healthcare provider that includes high-level classes of the environment such as: objects, locations, actions, etc. The model may define a set of properties that relate objects to each other, for example tasks and subtasks associated with objects and/or locations. Properties can have inverse or symmetric pairs, which further enables inference regarding artifacts. Some of the artifacts modeled as classes may include, but are not limited to:
Locations, with subtypes: region, point, room, floor, building, etc.
Actions, with subtypes: move, disable, enable, take, pause, transport, put, start task, complete task, etc.
Timing things or elements that allow machine understandable notions of “before”, “after”, “during”, etc.

Functional properties of the knowledge model allow instances of the model (e.g. a particular “room” in a house or workplace) to be interrelated in semantically rich ways, to the benefit of subsequent notifications. Examples may include, but are not limited to:
An object in the system—including the user—may have a dynamically changing location which, in the system, is represented as an association (either direct or indirect through a series of attribute interrelationships) between the object instance and a location instance.
Locations can be related to other locations via spatial relationships including, but limited to: northOf, southOf, eastOf, westOf, above, below, nearTo, farFrom, containedBy, contains.
Object location can have a degree of uncertainty from 0 (certain) to 1.0 (completely uncertain).
Object can have either (or both): a location (e.g., stockroom), and/or be coincident with another object (recursively) or that object may have a location.
If the user declares her current location (e.g., “office”) the system can infer a “move” action from her last location to the current one.
A pedometer/compass can emit “steps” into the system through an interface. Step patterns, such as those made when the user goes up a flight of stairs—can help the system infer location at a given moment. The system may improve location precision through step counting in conjunction with other knowledge (e.g., user declares “move to bedroom2” at which point steps are counted; since the physical layout is known, the system knows the progress).
Tasks are sequences of actions, including moving from place to place. A user's task efficacy (i.e., progress) may be inferred by counting steps taken between actions composing the task.
A pedometer/compass combination may report steps and current bearing; thus in the system if a past ‘fix’ location was known then current location can be estimated by understanding the spatial relationships (e.g., ‘northOf’/‘eastOf’) between the ‘fix’ location and other locations, by using other spatial relationships (e.g., ‘beside’, ‘near’ and ‘farFrom’) in combination with step-counting and possibly hard position fixes injected by the user.

With regard to positioning systems and technologies, system and method of the present disclosure may rely on some external components to provide coarse-grain positioning but it is largely agnostic to the specifics of those components—e.g., motion sensors, heat sensors, video camera sensors—so long as their sensed data can be understood at the server 102. For fine-grain positioning, the system and method of the present disclosure may include a novel type of interaction that is referred to herein as a voice “directive” (in which a user speaks an audible utterance that can be used to help the positioning system determine current position) that can have the effect of reducing the system's current uncertainty level regarding the users position, and a way to incorporate step counting and direction into productivity analysis.

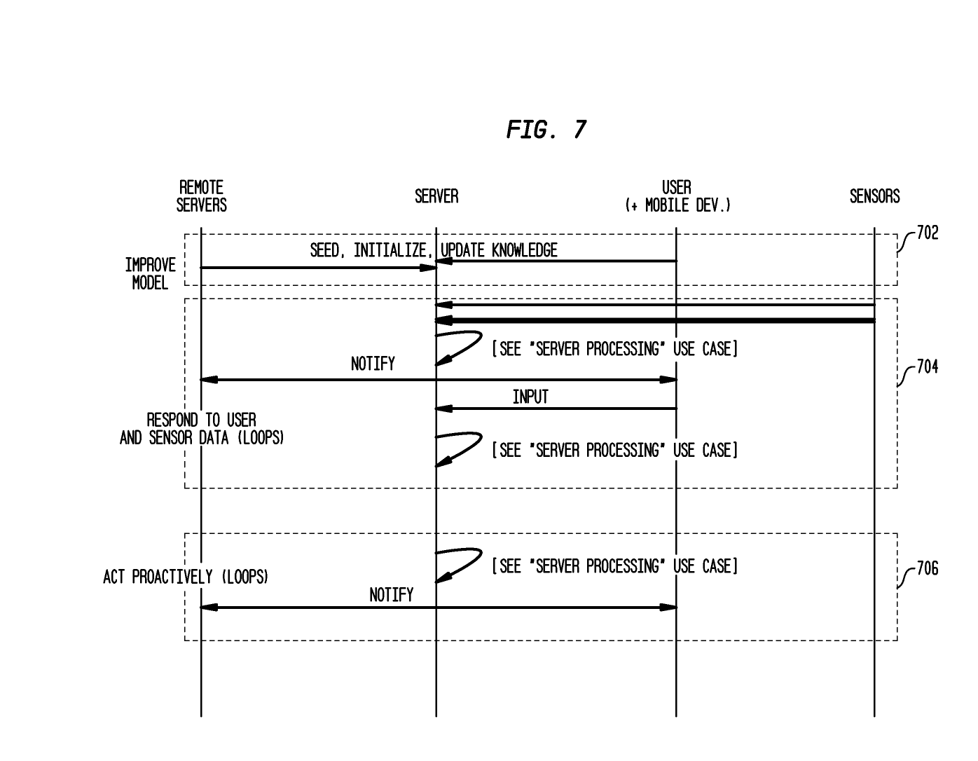

FIG. 7 illustrates a high level control loop of the system in one embodiment. As shown at 702, the server, remote servers, user and mobile device may seed and initialize the knowledge base to include and improve a model that stores information about the location, objects, tasks associated with the locations and objects, and other relationships among the locations and objects. As shown at 704, the server responds to user input and user actions, as well as sensor data. For instance, the server may notify the user and other remote servers by computing a user's new location and updating the user's tasks and which assisted media should be presented to the user. Also as shown at 706, the server may act proactively by first inferring user locations and tasks and optionally issuing assisted media to the user.

User position and other context may be reset from time to time, for instance, by having the user input voice directive or command into the mobile device. Each reset may improve the server's assumption of user positioning from the previous one. In one embodiment, a reset (or initialization) occurs when the user takes the device from a “dock” with a known location connected to a computer. As the user moves about the workplace (or another environment), each step or series of steps may be recognized. The server positions the user “probabilistically” in a model of the workplace based on the user's movements. In one aspect, steps and movements may be considered in clusters and the user's location within the house may be inferred probabilistically by examining all possible locations based on recent movement clusters and choosing the most likely location. User passage upon staircases may be inferred by both step counting and stride length estimation, which in turn may aid in positioning the user accurately (e.g., in the z-axis as the stairs are used to change level).

Each subsequent action may strengthen or weaken probabilistic positions. Periodically, the user may reset the system via a voice command. The command may be in natural language or using grammar from a pre-trained library. For example, a reset may be a location declaration, “I am at position the stockroom”. Reset may be an action that can be used to infer location, e.g., “I am opening the filing cabinet”, “removing file”. Reset may be input from another device, e.g., user turns on a computer and a signal is captured automatically and emitted to the system (e.g., the server) so that the system detects the computer being turned on automatically. After receiving such resetting inputs, the model may be updated to reflect the current state of the user.

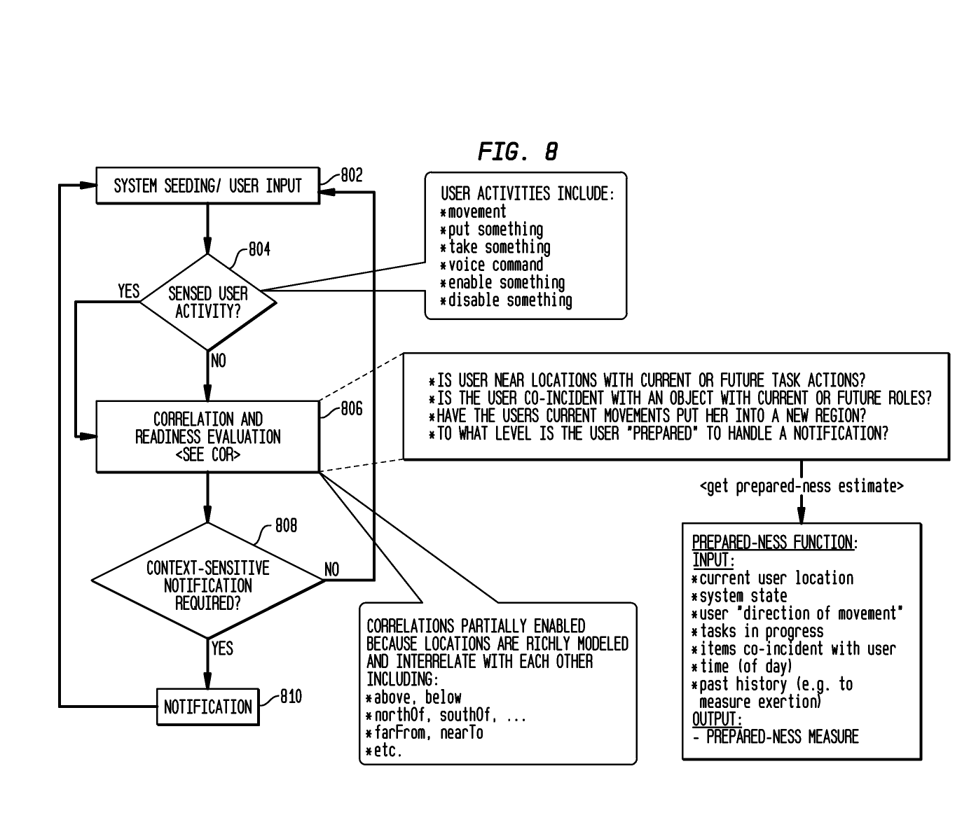

FIG. 8 shows system computation flow in one aspect. At 802, the system is seeded, e.g., with information about the environment, for example, home, workplace or like enclosed environment with its objects and location information, one or more user input and/or one or more user action. A data model, for example, may be created that models the environment with its objects, location information and related tasks, and other information. This may be an on-going process with the model being updated with new or changed information about the environment. The updating of the model metadata or instances may be performed dynamically as the information changes, or periodically at a predetermined interval.

At 804, the system (e.g., the server) senses user activities. Example of user activities may include but are not limited to user movement, user putting something, user taking something, user inputting voice command, user enabling something, user disabling something. User activities may be detected via devices such as sensors and mobile devices or informed directly by the user via an appropriate interface technology. The server processes and understands these actions.

At 806, the system correlates the user activity and also may perform readiness evaluation. Correlations are partially enabled because locations are richly modeled and interrelate with each other, for example with following spatial relationships: above, below, northOf, southOf, . . . farFrom, nearTo, etc. Readiness evaluation may estimate whether a user is near locations with current or future task actions, whether the user is co-incident with an object with current or future roles, whether the user's current movements put her into a new region, level to which the user is “prepared” to handle a notification, etc. Preparedness function may determine preparedness measure from parameters such as the current user location, system state, user “direction of movement”, tasks in progress, items co-incident with user, time (of day), or past history (e.g., to measure exertion) or combinations thereof. Preparedness measurement may be used to determine whether and what activity to suggest to the user. In one embodiment, the system may determine, by examining the system state, a user “ready” to perform a task because the user is at a particular location in the environment, but not “prepared” because the required objects to begin the task are not co-incident with the user.

At 808, it is determined whether context-sensitive notification is required. Context-sensitive notification refers to a notification that is generated with regard to the current state of the system (e.g., the current location of the user). If no notification is required the method proceeds to 802 to wait, for example, for user input and/or user activity. If notification is needed, however, a notification may be generated for the user. This notification may be, for example, a helpful suggestion whose goal is to increase efficiency of the user's actions, and it may be delivered, for example, to a mobile device on the person of the user.

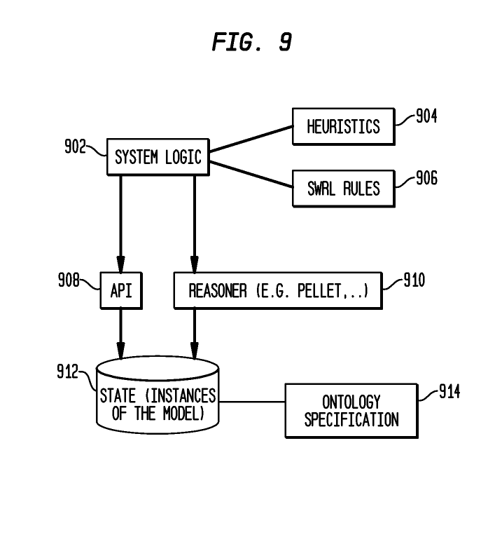

FIG. 9 is a diagram illustrating components of the present disclosure in one aspect. System logic may utilize an application program interface (API) 908 to store and retrieve information from state model 912. For example, voice recognition or simple graphical user interface (GUI) may allow household or the like actions to be registered and stored. Information in the model 912 may be created, added, parsed, searched or otherwise manipulated, using an application program interface (API). An example of an API is JENA™ API. The system logic 902 may infer location using the state information 912. The state information 912 may be stored and retrieved as a database such that attributes can interrelate instances. An extensible model, for example, an ontology specification 914, may be used as a reference to specify storage structure and/or the classes, attributes and relationships encoded in the state or model storage 912 for managing objects and their relationships.

Briefly, an ontology is a formal representation of a set of concepts within a domain and the relationships between or among those concepts. Ontology may be used, in part, to reason about the properties of that domain, and may be used to define the domain. An ontology specification 914 defines a model for describing the environment that includes a set of types, properties, and relationship types.

The system logic 902 may utilize heuristics 904, rules 906 and the state information 912 to infer current location, and determine associated tasks and assisted media to present to the user. A reasoning tool 910 (also referred to as a reasoner, reasoning engine, an inference or rules engine) may be able to infer logical consequences from a set of asserted facts, for example, specified in the heuristics 904, rules 906 and state information 912. PELLET™ is an example of a reasoning tool 912. Other tools may be used to infer user locations and to provide suggestions.

In addition, an instance of the model 912 may be created to capture physical layout of the workplace, functional layout, and/or personalized layout (e.g., some users may make different use of the same room). A reference model of a workplace can be used to help the system store and relate objects. For instance, a typical house may provide a default “index” of common objects and their associations with particular places in the house (e.g., towels, water, sink, in bathroom). Search mechanism allows objects to be found at a later time. For example, a sample flow may be that the user walks to the stockroom. In response, the system positions the user automatically thereabouts to a degree of probability. The user performs an action and declares the action verbally into the system, and the system stores the information in a database with multiple indices allowing future searching and processing (e.g., a search “by room” or “by floor”).

The model 912 may be implemented to recognized the following grammar (although not limited to only such): actions such as doing, putting, going, leaving, finishing, starting, taking, cleaning, including derivations and/or decompositions of those forms; subjects that include an extensible list from a catalog, e.g., file, computer, washing machine; places such as n-th floor (e.g., 2^{nd} floor), stockroom, bathroom, kitchen, and others; temporal such as now, later, actual time, and others. An example usage of such grammar may be:

action:subject:place:place:: “putting file in third drawer file cabinet”;

action:subject:time:: “starting laundry now”;

action:subject:: “leaving stockroom”.

The system is able to parse these composed utterances by extracting and recognizing the individual parts and updating the system state.

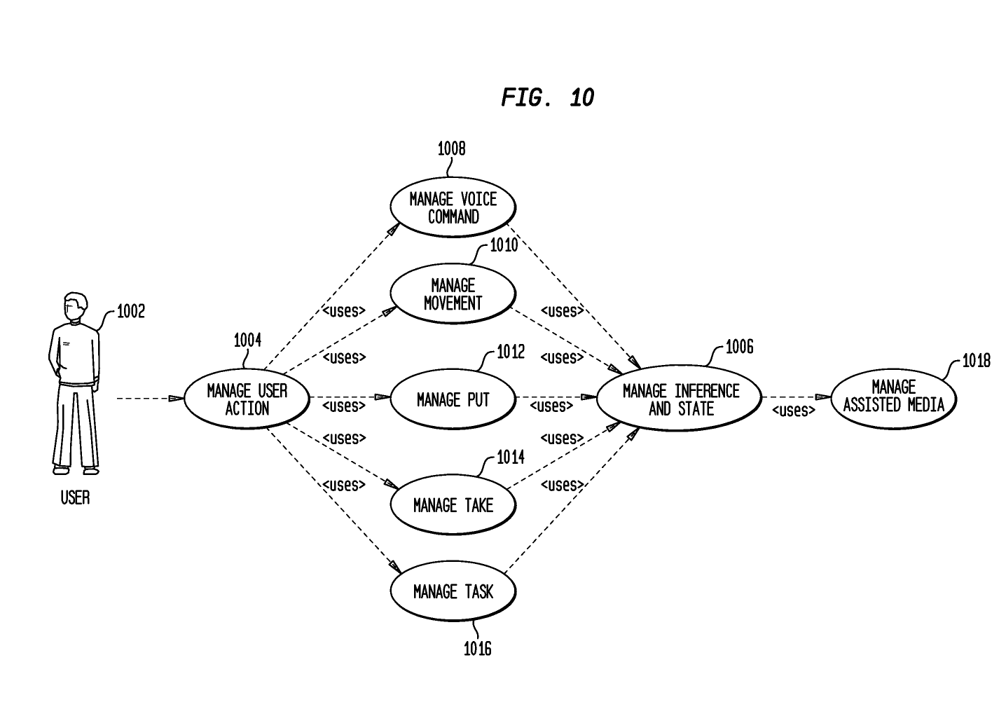

FIG. 10 illustrates a high-level use case diagram in one aspect. One or more user actions 1004 of a user 1002 are used to infer user state, location 1006. User actions may include (but not limited to) voice command 1008, movement 1010, putting 1012, taking 1014, and/or performing a task or activity 1016. The inferred state and location 1006 may be further used to determine which assisted media 1018 should be provided to the user. The assisted media demonstrates or instructs the user on how to complete tasks or activities at the inferred location. The assisted media is delivered may be delivered to a mobile phone or portable computing device co-located with the user.

The following scenarios illustrate advising or notifying the user. For example, the user may input using voice or speech a notice indicating that a task was begun, e.g., “starting laundry now.” The input is parsed and decomposed, and the state is updated accordingly (1006). The current user's state (e.g., encoded in ontology) may be compared and used to make inferences about what next steps are required and where (1006). The inferred steps may be logged and assisted media (1018) demonstrating how to complete the task sent to the user. In this particular example, the assisted media may be a video demonstrating “put laundry in dryer”. The system further infers that this step should be performed after the washing machine cycle is finished, which may be recorded as taking 45 minutes for example. Therefore, in this example, the system may send a message, “put laundry in dryer” in about 45 minutes from the time the user input the voice activation, for instance, unless the user is already near that goal.

As another example, the user's goals may be monitored in an on-going manner. For example, the system may monitor user's long term goal. An example may be to clean the attic. In this example, the system may monitor “clean attic” as a goal and the associated states. Every time the user is near the attic, and for example, the user's current state is “not busy with other things”, the user may be reminded of this long term goal task, i.e., “clean attic.” For example, user context may include cleaning attic as a long running task, doing laundry as a medium running task. For this long running task, a rule such “when near attic: 1) take an item from attic, 2) go downstairs” may be implemented. For the medium running task in this example, a rule “1) get laundry, 2) bring to machine, 3) start, 4) finish” may be implemented. A user voice may reset in den. Then the user may walk up the stairs. The system detects the user's movement and updates the user context. The system may use ontology to suggest “get laundry” and to suggest “cleaning attic”, for example, by taking some items downstairs. The user may choose pause the “cleaning attic” reminder, but get laundry, take it down to the machine and input, “starting laundry now.” The system updates the user context again, and sets a reminder for 45 minutes from now. Later, when the user is upstairs and the system infer the user's location, the user may get another “clean attic” reminder.

User may also specify the task status to “finished”, and the system updates the state of the model accordingly.

In another aspect, reminder or notifications may be followed by feedback request. For instance, the reminder or notifications may carry a click box that asks “was this helpful?” or “click here if you are not in this context” or other feedback questions. User feedback in this manner may reinforce suggestion classes that work well and inhibit poor ones.

The system and method of the present disclosure in one aspect utilizes location estimation after a reset followed by several steps, improves estimation by using spatial metadata, past actions, and use activities. Localization may be improved by clustering steps and inferring the staircase. In step clustering, the system may group together steps that occur in particular time series or with particular attributes. For example, when ascending a staircase one's steps are of decidedly similar stride-length and may have particular regularity. With a priori knowledge of the number of steps in the staircase the system infers the use of the staircase when it detects n steps with similar stride and regularity from an origin near the staircase base.

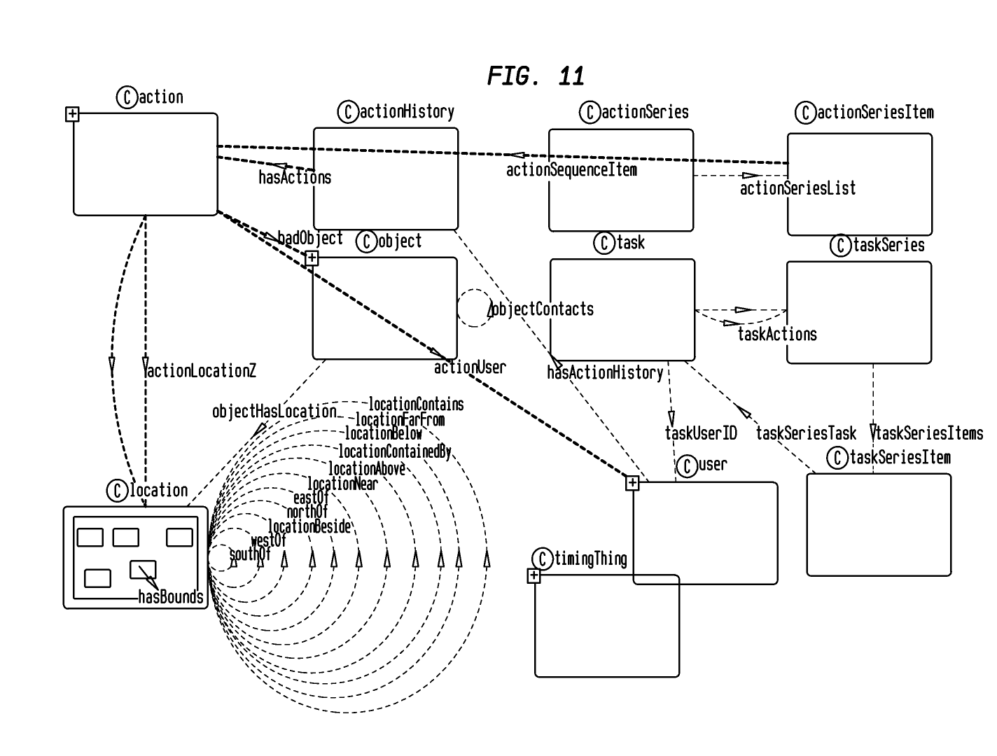

FIGS. 11-14 illustrate data and semantic models that may be utilized in the system and method of the present disclosure. FIG. 11 shows examples of properties and their domains and ranges. In the system model example, an action instance is associated with a location instance that in turn can be related with other location instances through relationships such as “northOf”. An action is associated with the user instance that in turn is associated with a number of task instances through the taskUserID relationship. An action is associated with an object instance which may in turn have associations with other object instances through an objectHasLocation or objectCoincidentWithObject relationship. Location or Task and action instances are grouped by taskSeries and actionSeries instances. A task has a relationship to a timingThing instance which provides temporal structure and constraints to the task.

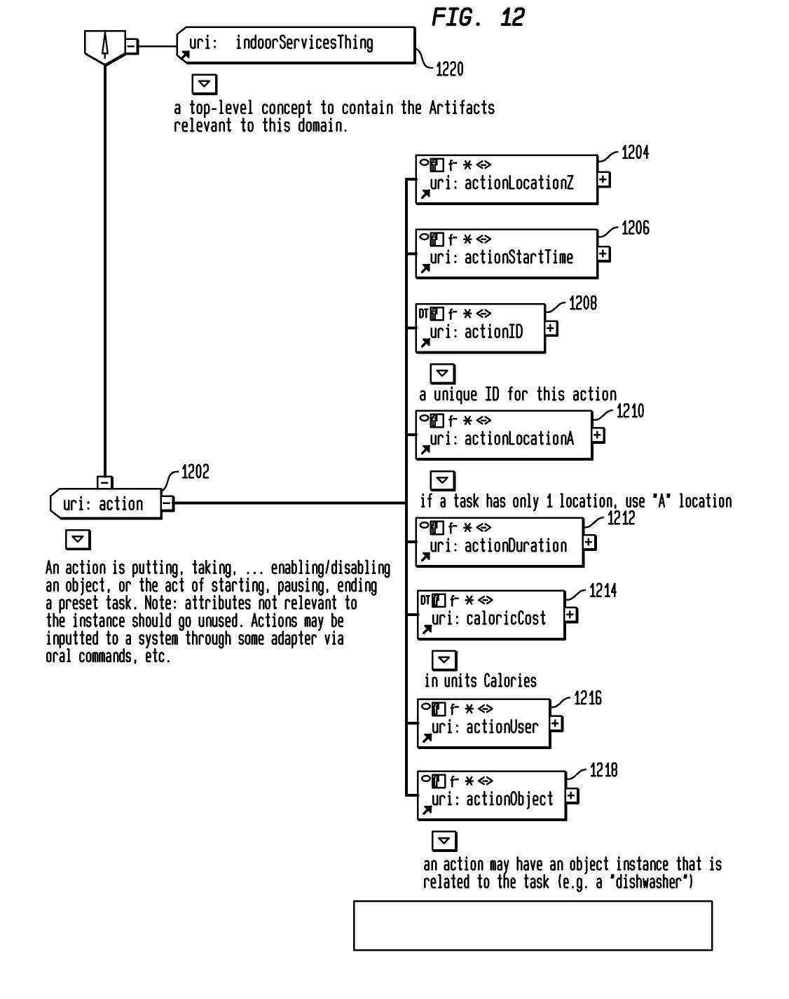

FIG. 12 illustrates example properties of an action object as an example. An “action” element 1202 may correspond to a real-world activity, which may include but is not limited to: putting, taking, enabling/disabling an object, or the act of starting, pausing, ending a preset task. As described above, actions may be input to a system through an adapter via oral commands, button clicks, typing, or other inputting methods. An action element may be an element of a top-level concept, for example, “indoorServicesthing” element 1204. A top-level concept 1220 may be the parent of many artifacts in a domain. Attributes of the action element 1202 may include “actionLocationZ” 1204 (the ending place of the action), “actionStartTime” 1206, “actionID” 1208 (a unique identifier), “actionLocationA” 1210 (the starting place of an action), “actionDuration” 1212, “CaloricCost” 1214 (the estimated caloric expenditure that this action requires), “actionUser” 1216 (the user instance performing the action), and “actionObject” 1218 (the object involved in the action). ActionLocationZ attribute 1204 may describe the location of the action; actionStartTime attribute 1206 may specify the time the action began; actionID attribute 1208 may identify this action with a unique identifier (id); actionLocationA 1210 may describe the location associates with a task associated with this action; actionDuration attribute 1212 may specify the duration the action lasted; caloricCost attribute 1214 may specify the number of calories the user may expand performing this action; actionUser attribute 1216 may identify the user, for example, by user identification such as name or others; and actionObject attribute 1218 may specify an object associated with this action.

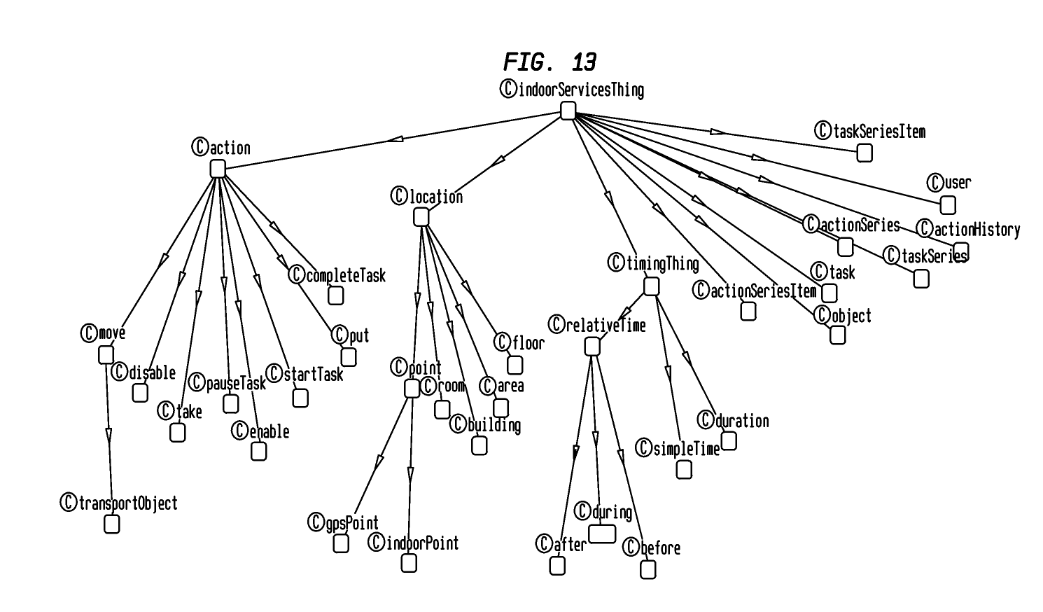

FIG. 13 illustrates an example class hierarchy of a knowledge model. In one embodiment, from a top level class that may be the ascendant of every other in the system, the model captures relevant information by using classes including but not limited to actions, locations, timingThings, users, tasks, objects, actionSeries, taskSeries, actionSeriesInstances, and taskSeriesInstances. These classes form, in part, the parent-child relationships of the system ontology and allow separation of concern while also allowing computation over these objects and their children. For example, the location class may have subclasses that comprise more specific types of locations that are understood by the system: floor, room, building, etc. Similarly, the action class may have subclasses comprising more specific types of actions understood by the system. Similarly, the timingThing may help the system encode all the subclasses of timing artifacts including relative and absolute time classes.

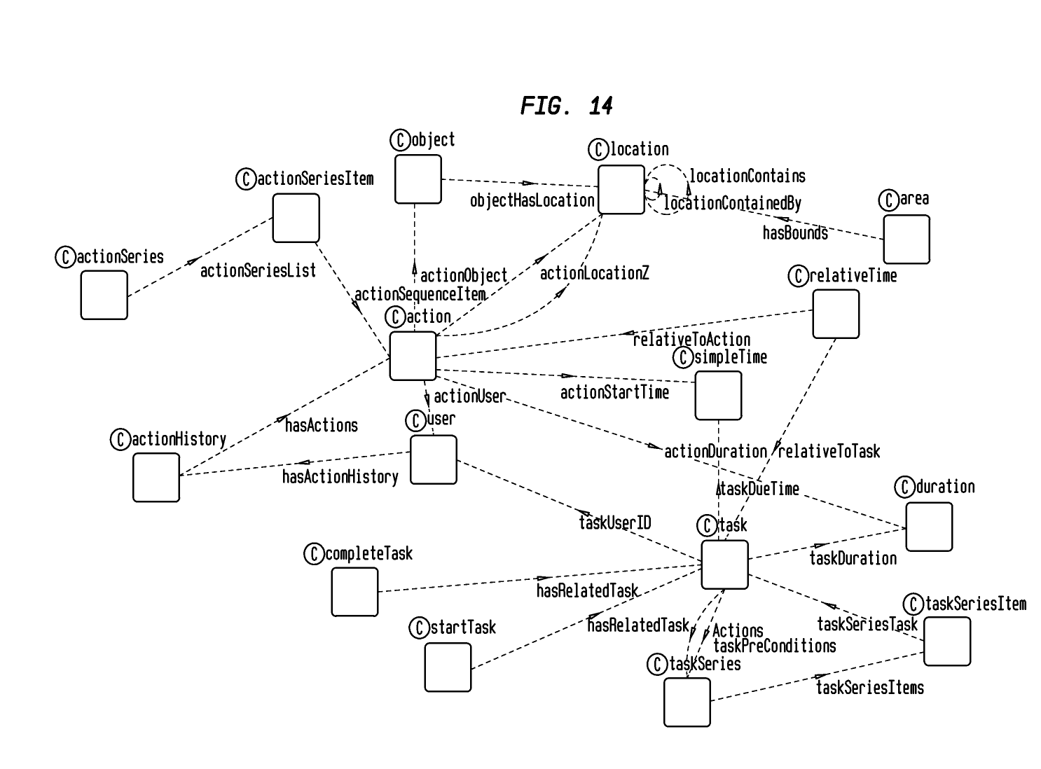

FIG. 14 illustrates example objects in a knowledge model with directed arcs representing properties and their ranges. For example, the figure illustrates that a task instance may have a due date time with the attribute taskDueTime to the class simpleTime. It may also have an expected taskDuration attribute with a relation to the class duration. Other relationships follow in this way so that the end result is a knowledge model of objects through a series of well defined classes.

The system and method of the present disclosure may be part of a category of next generation personal information services that involve the use of sensors, mobile devices, intelligent databases and fast context based event processing. This class of services of the “smart space” may include healthcare, wellness, Telematics and many other services.

The system and method of the present disclosure may be part of a category of next generation personal information services that involve the use of sensors, mobile devices, intelligent databases and fast context based event processing. This class of services of the “smart space” may include healthcare, wellness, Telematics and many other services.

As will be appreciated by one skilled in the art, the present invention may be embodied as a system, method or computer program product. Accordingly, the present invention may take the farm of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A computer implemented method for assisting a person with completion of a task comprising:
recognizing one or more objects in an environment associated with said task;
presenting one or more media that demonstrates a use of the one or more objects associated with said task to the person; and
interacting with the person throughout said task to measure progress towards the completion of the task.

2. The method of claim 1, further comprising:
decomposing said task into individual steps;
associating each individual step with one of the one or more media that demonstrates the use of the one or more objects associated with said task during the individual step; and
presenting the one media for each individual step to the person.

3. The method of claim 2, wherein interacting with the person provides an acknowledgment of completion of an individual step before presenting another media for a subsequent individual step associated with said task.

4. The method of claim 1, further comprising:
tagging the one or more objects in the environment with one or more tags, each tag operable to identify the one or more objects; and
associating each of the one or more objects with one of the media that demonstrates the use of the one or more objects.

5. The method of claim 1, further comprising:
inferring location of the person based on the recognized objects in the environment; and
suggesting one or more tasks to be performed based on a set of rules and heuristics associated with the location of the person and the recognized objects in the environment.

6. The method of claim 1, wherein recognizing one or more objects in the environment is accomplished by reading a bar code attached to each of the one or more objects or by sensing an RFID tag attached to each of the one or more objects.

7. The method of claim 6, wherein the bar code or the RFID tag is used to associate each object in the environment with an individual task.

8. A computer program product for assisting a person with completion of a task comprising:
a storage medium readable by a processor and storing instructions for operation by the processor for performing a method comprising:
recognizing one or more objects in an environment associated with said task;
presenting one or more media that demonstrates a use of the one or more objects associated with said task to the person; and
interacting with the person throughout said task to measure progress towards the completion of the task.

9. The computer program product of claim 8, further comprising:
decomposing said task into individual steps;
associating each individual step with one of the one or more media that demonstrates the use of the one or more objects associated with said task during the individual step; and
presenting the one media for each individual step to the person.

10. The computer program product of claim 9, wherein interacting with the person provides an acknowledgment of completion of an individual step before presenting another media for a subsequent individual step associated with said task.

11. The computer program product of claim 8, further comprising:
tagging the one or more objects in the environment with one or more tags, each tag operable to identify the one or more objects; and
associating each of the one or more objects with one of the media that demonstrates the use of the one or more objects.

12. The computer program product of claim 8, further comprising:
inferring location of the person based on the recognized objects in the environment; and
suggesting one or more tasks to be performed based on a set of rules and heuristics associated with the location of the person and the recognized objects in the environment.

13. The computer program product of claim 8, wherein recognizing one or more objects in the environment is accomplished by reading a bar code attached to each of the one or more objects or by sensing an RFID tag attached to each of the one or more objects in the environment.

14. The computer program product of claim 13, wherein the bar code or the RFID tag is used to associate each object in the environment with an individual task.

15. The computer program product of claim 14, wherein a model is formed from a combination of multiple individual tasks, said individual tasks using said objects, rules and heuristics in combination to form said task.

16. A system for assisting a person with completion of a task comprising:
a processor;
a knowledge base operable to store state information, rules, attributes and associations, associated with an environment, objects associated with the environment, and one or more users;
a server module operable to recognize one or more objects in an environment associated with said task, present one or more media that demonstrates a use of the one or more objects associated with said task to the person, and interact with the person throughout said task to measure progress towards the completion of the task.

17. The system of claim 16, further including:
a computing device co-located with a user and operable to receive one or more user input commands and communicate the one or more user input commands to the server module.

18. The system of claim 17, wherein the computing device is operable to recognize the one or more objects by reading a bar code attached to each of the one or more objects or by sensing an RFID tag attached to each of the one or more objects.
